(19) United States
(12) Patent Application Publication
(10) Pub. No.: US 2007/0195071 A1
(43) Pub. Date: Aug. 23, 2007

(54) HAND-HELD DEVICE WITH CHARACTER INPUT ROTARY WHEEL

(76) Inventors: Chin-Feng Chen, Shenzhen (CN); Tay-Yang Lin, Shenzhen (CN); Xiao-Guang Li, Shenzhen (CN); Te-Yao Yeh, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/562,963

(22) Filed: Nov. 22, 2006

(30) Foreign Application Priority Data
Feb. 18, 2006 (CN) 200610033848.X

(51) Int. Cl. G09G 5/00

(52) U.S. Cl. 345/184

(57) ABSTRACT

A hand-held device is provided. The hand-held device includes a rotary wheel, a first switch, a second switch, an encoder, a memory, and a controller. The rotary wheel has a plurality of positioning inputs. The encoder is responsive to operations on the rotary wheel and outputs positioning codes. The memory stores a plurality of input modes, wherein each input mode includes characters corresponding to positioning codes. The controller obtains an input mode from the memory, and shifts a current input mode to the input mode obtained in responsive to an input from the first switch. The controller inputs a character of the current input mode according to a positioning code that the encoder outputs in response to an input from the second switch. The above-mentioned rotary wheel can replace keyboard in the hand-held device.

### BACKGROUND

1. Field of the Invention

The present invention relates to a hand-held device, particularly to a hand-held device with a character input rotary wheel.

2. Description of Related Art

Hand-held devices, for example, mobile phones and PDAs, usually adopts a keypad to input characters. The keypad typically has fewer keys than a QWERTY keyboard. Furthermore, the key's size is smaller than a key's size of a normal keyboard. A user usually needs to operate keys a plurality of times to input one character. It is uncomfortable to operate small sized keys.

Rotary wheels are used as input apparatus in hand-held devices. For example, U.S. patent application Ser. No. 10/259,159, published May 22, 2003, entitled “Method and apparatus for use of rotational user inputs,” discloses a media player. The media player includes a display screen and an input device. The display screen displays media items. User rotates the input device to select a media item. U.S. Pat. No. 6,842,169, issued Oct. 19, entitled “Hand-held electronic device with multiple input mode thumbwheel,” it discloses a hand-held electronic device. The electronic device includes a thumbwheel as an auxiliary input device. Rotary wheels are used to select menu items, move cursor, but are unable or inconvenient to use as character input device.

Therefore what is needed is a hand-held device with a character input rotary wheel.

### SUMMARY OF THE INVENTION

A kind of hand-held device is disclosed. The hand-held device includes a rotary wheel, a first switch, a second switch, an encoder, a memory, and a controller. The rotary wheel has a plurality of positioning inputs. The encoder is responsive to operations on the rotary wheel and outputs positioning codes. The memory stores a plurality of input modes, wherein each input mode includes characters corresponding to positioning codes. The controller obtains an input mode from the memory, and shifts a current input mode to the input mode obtained in responsive to an input from the first switch. The controller inputs a character of the current input mode according to a positioning code that the encoder outputs in response to an input from the second switch.

Further features will be described or will become apparent in the course of the following detailed description when read in conjunction with the attached drawings, in which:

### BRIEF DESCRIPTION OF THE DRAWINGS

FIG. 1 is a schematic, front view of a hand-held device with a character input rotary wheel according to a preferred embodiment of the present invention; and

FIG. 2 is a schematic diagram of a hardware infrastructure of the hand-held device of FIG. 1.

### DETAILED DESCRIPTION OF THE INVENTION

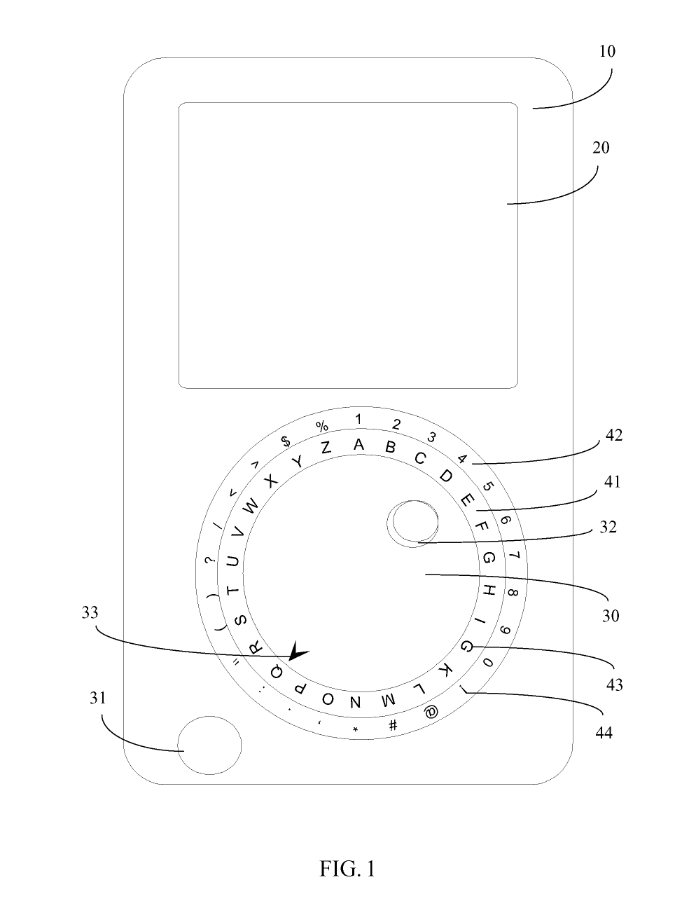

Referring to FIG. 1, a hand-held device is disclosed. The hand-held device 10 includes a display 20, a first character region 41, a second character region 42, and a rotary wheel 30. The first character region 41 and the second character region 42 respectively have twenty-six icons 43, 44. The icons 43, 44 are respectively arranged in the form of a circle. The icons 43, 44 may have a corresponding graphical label. The corresponding graphical labels of the first character region 41 are letters. The corresponding graphical labels of the second character region 42 are numbers, punctuation, and special symbols. The rotary wheel 30 has twenty-six positioning inputs. Each icon 43 or icon 44 is corresponding to a positioning input respectively.

The hand-held device 1 further has an indicator 33. The indicator 33 is positioned on the rotary wheel 30 to indicate the positioning input of the rotary wheel 30.

The hand-held device 1 further has a first switch 31 and a second switch 32 for selecting characters. The first switch 31 and the second switch 32 can be any appropriate input device. For example, in the embodiment as shown in FIG. 1, the first switch 31 and the second switch are in forms of buttons. The first switch 31 and the second switch 32 can be positioned on any appropriate place on the hand-held device 1. For example, in the embodiment as shown in FIG. 1, the first switch 31 is adjacent to the rotary wheel 30, and the second switch 32 is on the rotary wheel 30. Regarding a selection operation on the first switch 31 and second switch 32, it is described in detail below.

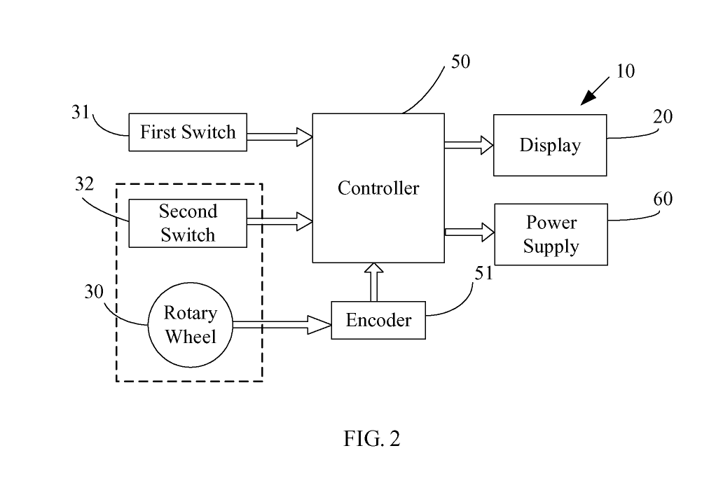

Referring to FIG. 2, a hardware infrastructure of the hand-held device 10 is disclosed. The hand-held device 10 further includes a controller 50, an encoder 51, and a memory 60. The controller 50 is connected to the first switch 31, the second switch 32, the encoder 51, the display 20, and the memory 60. The encoder 51 is further connected to the rotary wheel 30 and generates a positioning code corresponding to the positioning input of the rotary wheel 30. The memory 60 stores a first input mode corresponding to the first character region 41, and a second input mode corresponding to the second character region 42. The first input mode and the second input mode respectively includes character codes of the first character region 41 and the second character region 42. The controller 50 gets input modes from the memory 60. In response to a press input of the first switch 31, the controller 50 changes a current input mode. In response to a press input of the second switch 32, the controller 50 selects and sends a character of the current input mode to the display 20 according to the positioning code the encoder 51 outputs. The display 20 shows the character.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A hand-held device comprising:
a rotary wheel having a plurality of positioning inputs;
a first switch;
a second switch;
an encoder responsive to operation on the rotary wheel and outputting positioning codes;
a memory storing a plurality of input modes, wherein each input mode includes a plurality of characters corresponding to the positioning codes; and
a controller configured for obtaining an input mode from the memory, and shifting a current input mode to the input mode obtained in responsive to an input from the first switch;
the controller inputs a character of the current input mode according to a positioning code that the encoder outputs in response to an input from the second switch.

2. The hand-held device of claim 1, further comprising a plurality of character regions corresponding to the input modes, each character region including a plurality of icons corresponding to the positioning inputs of the rotary wheel, each icon including a character.

3. The hand-held device of claim 1, further comprising an indicator to indicate the positioning input of the rotary wheel.

4. The hand-held device of claim 3, wherein the indicator is placed on the rotary wheel.

5. The hand-held device of claim 1, wherein the first switch is adjacent to the rotary wheel.

6. The hand-held device of claim 1, wherein the second switch is placed on the rotary wheel.

7. The hand-held device of claim 5, wherein the first switch and the second switch are buttons.

8. The hand-held device of claim 6, wherein the first switch and the second switch are buttons.
